(19) United States
(12) Patent Application Publication
(10) Pub. No.: US 2017/0085548 A1
(43) Pub. Date: Mar. 23, 2017

(54) METHOD AND SYSTEM FOR MULTI CARRIER IMPLEMENTATION OF A DEVICE INSTALLED IN A VEHICLE

(71) Applicants: POOJA BISARYA, SAN DIEGO, CA (US); PRIYA JAIN, LOS ALTOS, CA (US); PRIYA BISARYA, SAN DIEGO, CA (US); LAKSHYA JAIN, LOS ALTOS, CA (US); ROBIN BISARYA, SAN DIEGO, CA (US); DAVE MARVIT, SAN FRANCISCO, CA (US); JEFF UBOIS, CHICAGO, IL (US)

(72) Inventors: POOJA BISARYA, SAN DIEGO, CA (US); PRIYA JAIN, LOS ALTOS, CA (US); PRIYA BISARYA, SAN DIEGO, CA (US); LAKSHYA JAIN, LOS ALTOS, CA (US); ROBIN BISARYA, SAN DIEGO, CA (US); DAVE MARVIT, SAN FRANCISCO, CA (US); JEFF UBOIS, CHICAGO, IL (US)

(21) Appl. No.: 14/862,528

(22) Filed: Sep. 23, 2015

(51) Int. Cl. H04L 29/06; H04L 29/08

(52) U.S. Cl. CPC H04L 63/08; H04L 67/12; H04L 63/10

(57) ABSTRACT

The present disclosure provides a method and system for enabling one or more users to access a multi carrier device of a vehicle. The method includes authenticating the user based on one or more attributes of a first set of attributes, matching the multi carrier device of the vehicle with a personal computing device associated with the user of the one or more users, replicating one or more attributes of a third set of attributes associated with a user identification information stored in the personal computing device onto the multi carrier device of the vehicle based on the authentication and the matching and providing a pre-determined set of services to the user on the multi carrier device based on the authentication of the user and the matching of the multi carrier device of the vehicle with the personal computing device associated with the user.

### TECHNICAL FIELD

The present invention relates to network based info-communication system and, in particular, relates to the network based info-communication system.

### BACKGROUND

With the advancement in technology, smart phones are increasingly being used for various applications in different industrial sectors. One of the industrial sectors implementing the smart phone technology is the automobile sector. Some of the topmost automobile manufacturing companies are providing users with a unique in-vehicle environment for a broad range of services. These applications supported by the smart phones allow a seamless integration of the smart phones with a vehicle's infotainment systems. For example, the smart phone can be used to stream music on the vehicle's audio system or for sharing real time content on the vehicle's display screen. Further, some of the specially designed smart phone applications enable the users to synchronize their smart phones with a car phone embedded/positioned in the vehicle for performing different functions. The synchronization takes places either through a wireless connection using Bluetooth, WiFi and the like or through a hardwired connection using a USB cable, a HDMI cable and the like. Moreover, earlier navigation systems in vehicles are being replaced by the smart devices which provide a fast and efficient navigation system for driver of the vehicle.

In addition, the existing methods and systems provision the users to link their smart phone with the in-vehicle system. Moreover, the existing methods and systems allow the users to sync their smart phones with the in-vehicle system for utilizing the smart phone applications in the vehicle. For example, Apple's in-vehicle system CarPlay allows the users to connect their iPhone with the vehicle's on-board system and authorizes the user to access specialized iPhone applications while driving the vehicle. The users are authorized to read text messages, make phone calls, navigate to desired places and the like. Further, the existing methods and systems facilitate the users to access features of the smart phones through an image of the smart phone by projecting it on a touch screen present in the vehicle. In addition, the existing methods and systems allow the users to link their smart phone with a phone installed in the vehicle and allows access only to the user driving the vehicle. One such method and system allows identification of the users operating the vehicle based on driving behavior or a unique mobile station identifier.

The existing methods and systems for utilizing mobile computing devices while travelling in the vehicle are inefficient. The users need to carry their devices each time they want to access the various applications on their devices in the vehicle. In addition, the existing systems and methods do not provide a proper identification means for allowing the users to access the device in the vehicle. The existing methods and systems have various security concerns. Moreover, the existing methods and systems do not allow the owner of the vehicle to specify a list of people who can access the device in the vehicle. Further, the existing methods and systems do not allow an automatic identity authentication of the user trying to access the device in the vehicle. In addition, the existing methods and systems do not allow a proper scheduling of identities based on time of day. Moreover, the existing methods and systems do not allow the users to specify a list of people who are not allowed to access the device installed in the vehicle.

In light of the above stated discussion, there is a need for a method and system that overcomes the above stated disadvantages.

### SUMMARY

In an aspect of the present disclosure, a computer-implemented method for enabling one or more users to access a multi carrier device of a vehicle is provided. The computer-implemented method includes authenticating, with a processor, a user of the one or more users based on one or more attributes of a first set of attributes; matching, with the processor, the multi carrier device of the vehicle with a personal computing device associated with the user of the one or more users; replicating, with the processor, one or more attributes of a third set of attributes associated with a user identification information stored in the personal computing device onto the multi carrier device of the vehicle based on the authentication and the matching and providing, with the processor, a pre-determined set of services to the user on the multi carrier device based on the authentication of the user and the matching of the multi carrier device of the vehicle with the personal computing device associated with the user. The authenticating is performed for verification of the user for accessing the multi carrier device of the vehicle. The matching is based on one or more attributes of a second set of attributes associated with the personal computing device of the user and the multi carrier device of the vehicle. The replicating is performed by copying of the one or more attributes of the third set of attributes stored in a carrier database associated with the user identification information stored in the personal computing device onto the multi carrier device of the vehicle.

In an embodiment of the present disclosure, the computer-implemented method further includes receiving, with the processor, the one or more attributes of the first set of attributes associated with the user present in the vehicle. In another embodiment of the present disclosure, the computer-implemented method further includes detecting, with the processor, the personal computing device associated with the authenticated user present in the vehicle.

In an embodiment of the present disclosure, the one or more attributes of the first set of attributes includes at least one of a username, a password, a fingerprint input of the user, a voiceprint input of the user, an image of the user, retina analysis of the user and a heartbeat input of the user.

In an embodiment of the present disclosure, the one or more attributes of the second set of attributes includes at least one of an operating system and a carrier associated with the personal computing device and the multi carrier device. The carrier provides mobile communication services to the user.

In an embodiment of the present disclosure, the multi carrier device supports a plurality of carriers and a plurality of operating systems.

In an embodiment of the present disclosure, the one or more attributes of the third set of attributes associated with the user identification information stored in the personal computing device includes one or more information associated with the user. The one or more information includes at least one of a unique directory number provided to the user, an ID associated with the user, billing information of the user, current location of the user, status of the user and one or more services rendered by the user.

In an embodiment of the present disclosure, the multi carrier device is controlled by at least one of a voice control, joysticks gestures on a touch screen or space, keyboard, mouse and touchpad.

In another aspect of the present disclosure, a system for enabling one or more users to access a multi carrier device of a vehicle is provided. The system includes an authentication engine in a processor, the authentication engine is configured to authenticate a user of the one or more users based on one or more attributes from a first set of attributes; a comparator module in the processor, the comparator module is configured to match the multi carrier device of the vehicle with a personal computing device associated with the user of the one or more users; a replication engine in the processor, the replication engine is configured for replicating one or more attributes of a third set of attributes associated with a user identification information stored in the personal computing device onto the multi carrier device of the vehicle based on the authentication and the matching and an execution engine in the processor, the execution engine in the processor is configured to provide a pre-determined set of services to the user on the multi carrier device based on the authentication of the user and the matching of the multi carrier device of the vehicle with the personal computing device associated with the user. The authentication is performed for verification of the user for accessing the multi carrier device of the vehicle. The matching is based on one or more attributes of a second set of attributes associated with the personal computing device of the user and the multi carrier device of the vehicle. The replicating is performed by copying of the one or more attributes of the third set of attributes stored in a carrier database associated with the user identification information located in the personal computing device onto the multi carrier device of the vehicle.

In an embodiment of the present disclosure, the system further includes a receiving module in the processor, the receiving module is configured to receive the one or more attributes of the first set of attributes associated with the user present in the vehicle. In another embodiment of the present disclosure, the system further includes a detection module in the processor, the detection module is configured to detect the personal computing device associated with the authenticated user present in the vehicle.

In an embodiment of the present disclosure, the one or more attributes of the first set of attributes includes at least one of a username, a password, a fingerprint input of the user, a voiceprint input of the user, an image of the user, retina analysis of the user and a heartbeat input of the user.

In an embodiment of the present disclosure, the one or more attributes from the second set of attributes includes at least one of an operating system and a carrier associated with the personal computing device and the multi carrier device. The carrier provides mobile communication services to the user.

In an embodiment of the present disclosure, the multi carrier device supports a plurality of carriers and a plurality of operating systems.

In an embodiment of the present disclosure, the one or more attributes from the third set of attributes associated with the user identification information stored in the personal computing device includes one or more information associated with the user. The one or more information includes at least one of a unique directory number provided to the user, an ID associated with the user, billing information of the user, current location of the user, status of the user and one or more services rendered by the user.

In an embodiment of the present disclosure, the multi carrier device is controlled by at least one of a voice control, joysticks gestures on a touch screen or space, keyboard, mouse and touchpad.

In yet another aspect of the present disclosure, a computer system is provided. The computer system includes a non-transitory computer readable medium storing a computer readable program; the computer readable program when executed on a computer causes the computer to perform steps. The steps include authenticating a user of one or more users based on one or more attributes of a first set of attributes, matching a multi carrier device of a vehicle with a personal computing device associated with the user of the one or more users, replicating one or more attributes of a third set of attributes associated with a user identification information located in the personal computing device onto the multi carrier device of the vehicle based on the authentication and the matching and providing a pre-determined set of services to the user on the multi carrier device based on the authentication of the user and the matching of the multi carrier device of the vehicle with the personal computing device associated with the user. The authentication is performed for verification of the user for accessing the multi carrier device of a vehicle. The matching is based on one or more attributes of a second set of attributes associated with the personal computing device of the user and the multi carrier device of the vehicle. The replicating is performed by copying of the one or more attributes of the third set of attributes stored in a carrier database associated with the user identification information located in the personal computing device onto the multi carrier device of the vehicle.

In an embodiment of the present disclosure, the computer readable program when executed on the computer causes the computer to perform a further step of receiving the one or more attributes of the first set of attributes associated with the user present in the vehicle.

In another embodiment of the present disclosure, the computer readable program when executed on the computer causes the computer to perform a further step of detecting the personal computing device associated with the authenticated user present in the vehicle.

In an embodiment of the present disclosure, the one or more attributes of the first set of attributes includes at least one of a username, a password, a fingerprint input of the user, a voiceprint input of the user and a heartbeat input of the user.

### BRIEF DESCRIPTION OF THE FIGURES

Having thus described the invention in general terms, reference will now be made to the accompanying drawings, which are not necessarily drawn to scale, and wherein:

FIG. 1A illustrates a system for enabling one or more users to access a multi carrier based device, in accordance with various embodiments of the present disclosure;

FIG. 1B illustrates a system showing various components associated with a personal computing device, in accordance with various embodiments of the present disclosure;

FIG. 2 illustrates a block diagram of a communication device, in accordance with various embodiments of the present disclosure; and

FIG. 3 is a flow chart enabling the one or more users to access the multi carrier based device, in accordance with the various embodiments of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

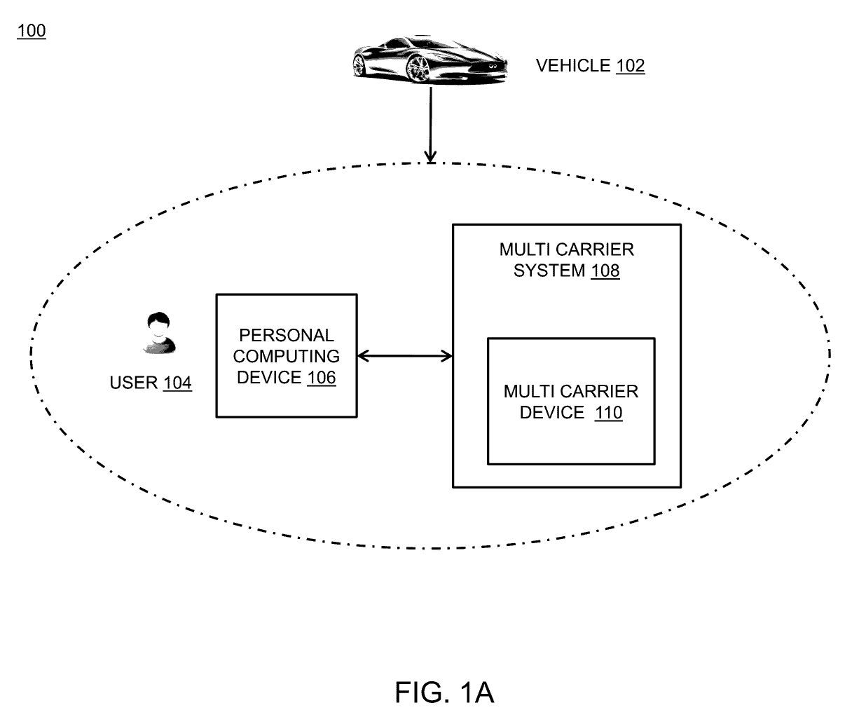

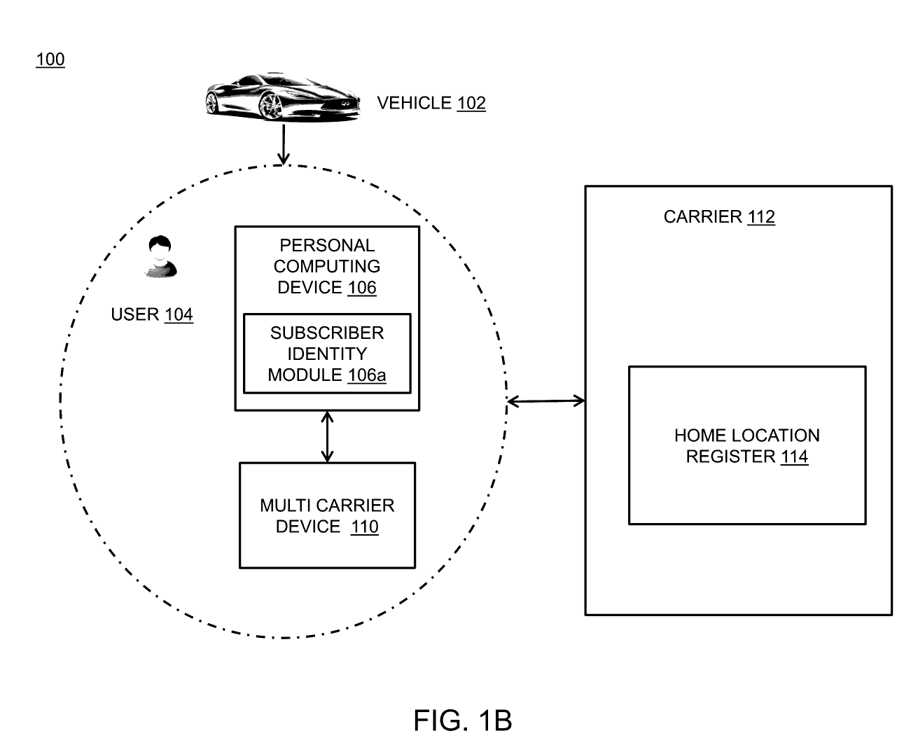

FIG. 1A illustrates a system 100 for enabling one or more users to access a multi carrier based device of a vehicle, in accordance with various embodiments of the present disclosure. The system 100 includes a vehicle 102. The vehicle 102 may be any type of conveyance for travelling from one place to another. Examples of the vehicle 102 include but may not be limited to a car, a truck, a bus, a jeep, an aircraft, a boat, a submarine, a helicopter, a motorcycle and a train. Further, the vehicle 102 includes a personal computing device 106 associated with a user 104, a multi carrier system 108 and a multi carrier device 110. The user 104 is any individual or a person sitting in the vehicle 102. In an embodiment of the present disclosure, the user 104 is a legal owner of the vehicle 102.

In addition, the personal computing device 106 is associated with the user 104. In an embodiment of the present disclosure, the user 104 is the owner of the personal computing device 106. Examples of the personal computing device 106 includes a smart phone, a tablet, a desktop computer, a laptop or any other electronic portable device capable of providing communication services to the user 102. In addition, the personal computing device 106 runs on a specific operating system. Examples of the types of the operating system include but may not be limited to Android OS, iOS, BADA, Windows, Symbian and Blackberry OS.

Moreover, the personal computing device 106 is equipped with a Subscriber Identification Module card (hereafter “SIM” Card). The SIM card is a portable memory chip present in the personal computing device 106 for providing the communication services to the user 104 on the personal computing device 106. In addition, the SIM card stores one or more information corresponding to the user 104. The one or more information include but may not be limited to identity of the user 104, location of the user 104, phone number of the user 104, network authorization data, personal security keys, contacts list and text messages.

Further, the SIM card in the personal computing device 106 is associated with a specific carrier. In an embodiment of the present disclosure, the carrier provides the user 104 with the SIM card when the user 104 opens an account with the carrier. In an embodiment of the present disclosure, the user 104 is registered and authorized for utilizing various services provided by the carrier. Examples of the various services provided by the carrier include but may not be limited to calling services, data transmission services (GPRS services), and short messaging services. Moreover, the carrier is any company or organization that provides the communication services (voice and data services) to the user 104 on the personal computing device 106. Examples of the carrier include Verizon Wireless, Sprint, AT&T, T-Mobile, US Cellular and the like. For example, a user X is sitting in an AUDI R8 and possesses a Samsung Galaxy Note 4 smart phone with him/her. The Samsung Galaxy Note 4 smart phone runs on an Android operating system. Further, the Samsung Galaxy Note 4 smart phone is equipped with a subscriber identity module card of the carrier Verizon Wireless.

Going further, the vehicle 102 is equipped with the multi carrier system 108. The multi carrier device 110 is associated with the multi carrier system 108. In an embodiment of the present disclosure, the multi carrier device 110 is a part of the multi carrier system 108.

Further, the multi carrier system 108 aids in functioning of the multi carrier device 110. Moreover, the multi carrier device 110 is installed/embedded inside the vehicle 102 at an appropriate place. Further, the appropriate place for installing/embedding the multi carrier device 110 include dashboard of the vehicle 102, front seat of the vehicle 102, driving seat of the vehicle 102, floorboard of the vehicle 102 and the like. In an embodiment of the present disclosure, the multi carrier device 110 is installed/embedded at time of purchasing of the vehicle 102 by the user 104.

The multi carrier device 110 provides a set of services to the user 104 in the vehicle 102. The multi carrier device includes a smart phone, a tablet computer or any other portable communication device capable of providing the set of services to the user 104 sitting in the vehicle 102. The set of services provided by the multi carrier device 110 include calling services, short messaging services, data services, one or more applications and the like. In an embodiment of the present disclosure, the multi carrier device 110 is fixed and immovable and specially designed to be operated inside the vehicle 102. Further, the multi carrier device 110 supports a plurality of carriers. In an embodiment of the present disclosure, the multi carrier device 110 is equipped with providing multi carrier functionality to the user 104.

In another embodiment of the present disclosure, the multi carrier device 110 is a device equipped with a Subscriber Identification Module card (hereinafter “SIM” card) supporting the plurality of carriers. In yet another embodiment of the present disclosure, the SIM card inside the multi carrier device 110 is a universal SIM card providing services from various carriers on a single device (multi carrier device 110). In an embodiment of the present disclosure, the multi carrier device 110 is equipped with a plurality of identification equipments. In another embodiment of the present disclosure, each of the plurality of identification equipment provide services from a different carrier of the plurality of carriers. The various carriers supported by the multi carrier device 110 include the Verizon Wireless, the Sprint, the AT&T, the T-Mobile, the US Cellular and the like.

In an embodiment of the present disclosure, the multi carrier device 110 is equipped with equipment for providing various services from various carriers on the single device (the multi carrier device 110). In another embodiment of the present disclosure, the equipment is associated with a unique identification code.

In addition, the multi carrier device 110 supports a plurality of operating systems. In an embodiment of the present disclosure, the multi carrier device 110 provides the user 104 with the multiple operating system environments in the vehicle 102. The plurality of operating systems supported by the multi carrier device 110 include but may not be limited to the Android OS, the iOS, the BADA OS, the Windows OS, the Symbian OS and the Blackberry OS.

It may be noted that in FIG. 1A, the user 104 is associated with the personal computing device 106, however those skilled in the art would appreciate that there are more number of users associated with one or more personal computing devices. It may also be noted that in FIG. 1A, the multi carrier device 110 is embedded/installed in the vehicle 102, however those skilled in the art would appreciate that there are one or more devices installed/embedded in the vehicle 102.

FIG. 1B illustrates a system 100 showing various components associated with the personal computing device 106, in accordance with various embodiments of the present disclosure. It may be noted that to explain the system elements of FIG. 1B, references will be made to the system elements of the FIG. 1A. The system 100 includes the vehicle 102. Further, the vehicle 102 includes the personal computing device 106 associated with a user 104, a subscriber identity module 106a, the multi carrier device 110, a carrier 112 and a home location register 114. The various components of the personal computing device 106 aid in the enabling of the access of the multi carrier device 110 embedded/installed in the vehicle 102.

Going further, the subscriber identity module 106a is associated with the personal computing device 106. In an embodiment of the present disclosure, the subscriber identity module 106a is located inside the personal computing device 106. The subscriber identity module 106a is the portable memory chip present in the personal computing device 106 for providing the communication services to the user 104 on the personal computing device 106 (as exemplary stated above in the detailed description of FIG. 1A). In an embodiment of the present disclosure, the subscriber identity module 106a is associated with a unique ID.

In addition, the personal computing device 106 is associated with the carrier 112. The carrier 112 provides telecommunication services to the user 104 through the subscriber identity module 106a located in the personal computing device 106 (as exemplary stated above in the detailed description of FIG. 1A). In an embodiment of the present disclosure, the carrier 112 authenticates or authorizes the user 104 to utilize the telecommunication services of the carrier 112. In another embodiment of the present disclosure, the user 104 provides the carrier 112 with one or more information associated with an identity of the user 104. The carrier 112 provides the user 104 with a unique directory number associated with the subscriber identity module 106a.

Moreover, the carrier 112 is associated with the home location register 114. The home location register 114 is a central database for storing permanent subscriber (the user 104) information. In addition, the home location register 114 is an integral part of CDMA (Code Division Multiple Access), TDMA (time division multiple access) and GSM (Global System for Mobile communications) networks. The one or more information provided by the user 104 for accessing the telecommunication services is stored in the home location register 114 of the carrier 112. The one or more information include but may not be limited to name of the user 104, an ID of the user 104, services rendered or requested by the user 104, calling plan, general packet radio service settings of the user 104, current location of the user 104 and call divert settings.

Further, the home location register 114 stores the unique directory number and a unique identifier corresponding to the subscriber identity module 106a. The unique directory number and the unique identifier enable the home location register 114 to uniquely identify the user 104. The unique directory number is a telephone number allotted to the user 104 for accessing voice and data services. The home location register 114 aids in the identification or authentication of the user 104 for accessing the multi carrier device 110 embedded/installed in the vehicle 102 (as described below in the patent application). In an embodiment of the present disclosure, the carrier 112 and the home location register 114 is associated with a central server for storing the permanent subscriber information.

It may be noted that in FIG. 1B, the subscriber identity module 106a in the personal computing device 106 is associated with the carrier 112, however those skilled in the art would appreciate that there are one or more subscriber identity module cards in one or more personal computing devices associated with one or more carriers.

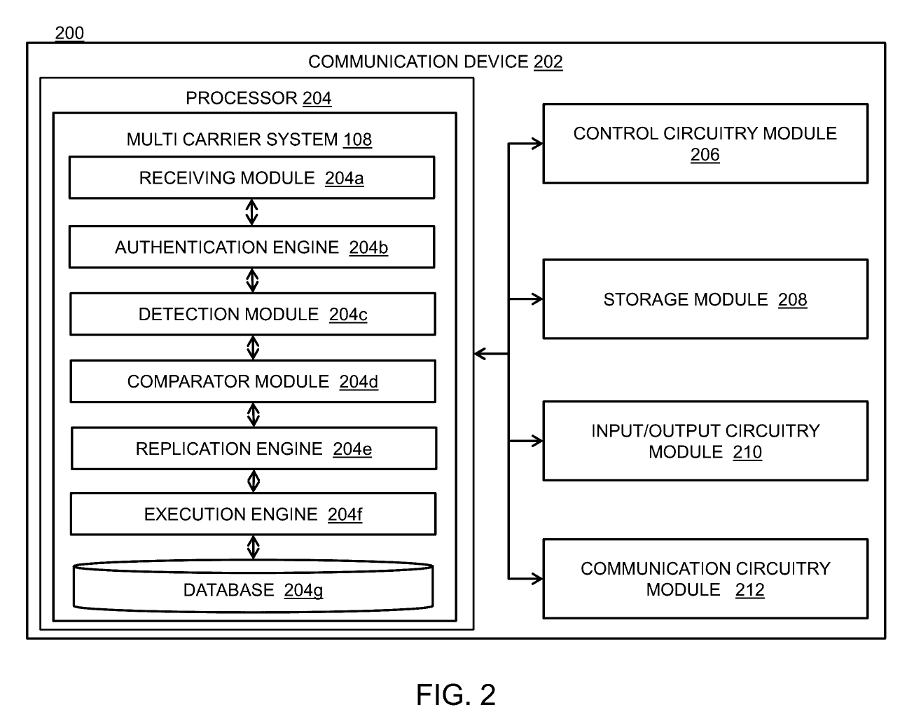

FIG. 2 illustrates a block diagram 200 of a communication device 202, in accordance with various embodiments of the present disclosure. It may be noted that to explain the system elements of FIG. 2, references will be made to the system elements of FIG. 1A and FIG. 1B. The communication device 202 includes a processor 204, a control circuitry module 206, a storage module 208, an input/output circuitry module 210 and a communication circuitry module 212. Further, the processor 204 includes a receiving module 204a, an authentication engine 204b, a detection module 204c, a comparator module 204d, a replication engine 204e, an execution engine 204f and a database 204g. The above stated components of the processor 204 enable working of the multi carrier system 108 for enabling the user 104 to access the multi carrier device 110 of the vehicle 102.

Going further, the user 104 present in the vehicle 102 wants to access the multi carrier device 110. The receiving module 204a in the processor 204 receives one or more attributes of a first set of attributes from the user 104 present in the vehicle 102. The received one or more attributes of the first set of attributes include a username of the user 104, a password of the user 104, a fingerprint input of the user 104, a voiceprint input of the user 104, an image of the user 104, retina analysis of the user 104, a heartbeat input of the user 104 or any other input for enabling authorization of the user 104 for accessing the multi carrier device 110. In an embodiment of the present disclosure, the one or more attributes of the first set of attributes is provided by the carrier 112 associated with the subscriber identity module 106a located in the personal computing device 106.

In another embodiment of the present disclosure, the multi carrier device 110 is equipped with a face scanner for facial recognition of the user 104, a heartbeat scanner for taking heartbeat input of the user 104, a voice recorder for taking voice input of the user 104 and a fingerprint scanner for the fingerprint input of the user 104. In yet another embodiment of the present disclosure, the multi carrier system 108 prompts the user 104 to enter the one or more attributes of the first set of attributes for accessing the multi carrier device 110. In yet another embodiment of the present disclosure, the multi carrier system 108 asks the user 104 to stay still for taking the face recognition input. In yet another embodiment of the present disclosure, the user 104 provides the fingerprint input on screen of the multi carrier device 110.

In yet another embodiment of the present disclosure, the one or more attributes of the first set of attributes is received through one or more applications installed on the multi carrier device 110 specially designed for receiving the one or more attributes of the first set of attributes.

Extending the above stated example, the user X wants to access a device Y installed in the car AUDI R8. The multi carrier system 108 asks the user X to enter his/her username and password, voice input and fingerprint input. The user X enters the username MIKE412 and password ask12345. The user X enters his/her voice input through the voice recorder present in the device Y. The user X also enters his/her thumb fingerprint input though the fingerprint scanner present in the device Y. The multi carrier system 108 recognizes the user X based on the inputs provided by the user X.

The authentication engine 204b in the processor 204 authenticates the user 104 based on the received one or more attributes of the first set of attributes from the user 104. The authentication of the user 104 is performed for verification of the user 104 for accessing the multi carrier device 110. In an embodiment of the present disclosure, the authentication engine 204b authenticates the user 104 by comparing the one or more attributes of the first set of attributes provided by the user 104 with a pre-defined set of attributes previously stored in the database of the carrier 112. In another embodiment of the present disclosure, the carrier 112 maintains the pre-defined set of attributes for the user 104 and other one or more users. In yet another embodiment of the present disclosure, the carrier 112 takes the pre-defined set of attributes from the user 104 for registering the user 104 on the multi carrier system 108.

In an embodiment of the present disclosure, the pre-defined set of attributes is stored in the central server associated with the carrier 112. In an embodiment of the present disclosure, the pre-defined set of attributes is stored at time of purchase and registration of the vehicle 102. In an embodiment of the present disclosure, the user 104 provides the pre-defined set of attributed for configuring the multi carrier device 110 for defining a list of other one or more users who can access the multi carrier device 110. In an embodiment of the present disclosure, the user 104 selects the one or more attributes from the first set of attributes based on his/her choice which would be required at the time of authentication. In an embodiment of the present disclosure, a copy of the first set of attributes are stored on a cloud server for allowing easy access to the first set of attributes.

Moreover, the detection module 204c in the processor 204 detects the personal computing device 106 associated with the user 104. The detection of the personal computing device 106 is performed by using any wireless communication technology. In an embodiment of the present disclosure, the detection module 204c performs scanning for searching one or more devices to connect with and provides the user 104 with one or more options. The wireless communication technology for detecting the personal computing device 106 include but may not be limited to Bluetooth, Wi-Fi or any other type of wireless communication technology known in the art for detecting the personal computing device 106. In an embodiment of the present disclosure, the detection of the personal computing device 106 is performed automatically by the multi carrier system 108. In an embodiment of the present disclosure, the personal computing device 106 is directly connected to the multi carrier device 110 with a cable for detection of the personal computing device 106. In another embodiment of the present disclosure, the detection is performed when the personal computing device 106 is in a proximate distance to the multi carrier device 110.

Further, the comparator module 204d in the processor 204 matches the multi carrier device 110 of the vehicle 102 with the detected personal computing device 106 associated with the user 104. The matching is based on one or more attributes of a second set of attributes associated with the personal computing device 106 and the multi carrier device 110. Further, the one or more attributes of the second set of attributes include but may not be limited to an operating system and a carrier associated with the multi carrier device 110 and the personal computing device 106. In an embodiment of the present disclosure, the comparator module 204d compares the operating system of the personal computing device 106 with the plurality of operating systems supported by the multi carrier device 106. In addition, the comparator module 204d compares the carrier associated with the subscriber identity module 106a located in the personal computing device 106 with the plurality of carriers supported by the multi carrier device 106. In an embodiment of the present disclosure, the comparator module 204d checks the operating system compatibility and the carrier compatibility between the multi carrier device 110 and the personal computing device 106.

In an embodiment of the present disclosure, a type of the operating system and a type of the carrier associated with the personal computing device 106 is inferred through an application installed on the personal computing device 106. In an embodiment of the present disclosure, the application is triggered for detecting the operating system and the carrier. In an embodiment of the present disclosure, the application transmits information associated with the operating system and the carrier to the multi carrier device 110.

Continuing with the above stated example, the user X is sitting in the car AUDI R8 possessing the Samsung Galaxy Note 4 smart phone running on the Android operating system. The Samsung Galaxy Note 4 is equipped with the subscriber identity module card Z of the carrier Verizon Wireless. The device Y installed in the car AUDI R8 supports operating systems (say iOS, Android OS, Windows OS and BADA OS) and supports carriers (say Sprint, US cellular and Verizon Wireless). The comparator module 204d matches the operating system (Android) and the carrier (Verizon Wireless) of the smart phone Samsung Galaxy Note 4 with the operating system (iOS, Android OS, Windows OS and BADA OS) and the carriers (Sprint, US cellular and Verizon Wireless).

Going further, the replication engine 204e in the processor 204 replicates one or more attributes of a third set of attributes associated with a user identification information stored in the personal computing device 106 onto the multi carrier device 110 of the vehicle 102. The replication is based on the authentication of the user 104 for accessing the multi carrier device 104 and a positive matching of the operating system and the carrier of the personal computing device 106 and the multi carrier device 110. Moreover, the replication is performed by physically copying of the one or more attributes of the third set of attributes associated with the user identification information stored in the personal computing device 106 stored in a carrier database onto the SIM card (the universal SIM card) located in the multi carrier device 110.

In an embodiment of the present disclosure, the user identification information corresponds to one or more information associated with the user 102 stored on the personal computing device 106a. 106a In an embodiment of the present disclosure, the user identification information is stored on an application installed on the personal computing device 106. In an embodiment of the present disclosure, the carrier database is the home location register 114.

In an embodiment of the present disclosure, the one or more attributes of the third set of attributes corresponds to home location registry information associated with the user identification information stored in the personal computing device 106. In another embodiment of the present disclosure, the one or more attributes of the third set of attributes is stored in the home location register 114. The one or more attributes of the third set of attributes includes one or more information associated with the user 104. The one or more information includes but may not be limited to a unique directory number provided to the user 104, an ID associated with the user 104, billing information of the user 104, current location of the user 104, status of the user 104 and one or more services rendered by the user 104.

Further, the home location registry information includes an International Mobile Subscriber Identity (hereinafter “IMSI”) information and Mobile Station International Subscriber Directory Number (hereinafter “MSISDN”) information. The IMSI is an internationally standardized unique number for identifying a subscriber (the user 104). The MSISDN is a number for uniquely identifying a subscription of the user 104 on the carrier 112 network. In an embodiment of the present disclosure, the MSISDN is a telephone number to the subscriber identity module 106a card in the personal computing device 106. In an embodiment of the present disclosure, the IMSI information and the MSISDN information is stored on the home location register 114.

In an embodiment of the present disclosure, the replication engine 204e utilizes the IMSI number associated with the subscriber identity module 106a for the identification of the carrier 112. In addition, the replication engine 204e copies the MSISDN number associated with the subscriber identity module 106a in the personal computing device onto the SIM card of the multi carrier device 110. In an embodiment of the present disclosure, the MSISDN number of the personal computing device 106 is the MSISDN number of the multi carrier device 110. In another embodiment of the present disclosure, the multi carrier system 108 provisions the user 104 to utilize the same MSISDN number on the multi carrier device 110.

In yet another embodiment of the present disclosure, the multi carrier system 108 allows the user 104 to utilize voice services and data services on the multi carrier device 110 through the MSISDN number or the telephone number associated with the subscriber identity module 106a in the personal computing device 106. In yet another embodiment of the present disclosure, the multi carrier device 110 utilizes an existing calling plan associated with the MSISDN number of the subscriber identity module 106a in the personal computing device 106. In yet another embodiment of the present disclosure, the user 104 can use the multi carrier device 110 in place of the personal computing device 106 for performing one or more functions.

In yet another embodiment of the present disclosure, the replication engine 204e copies contact information of one or more individuals stored in the subscriber identity module 106a located in the personal computing device 106. In yet another embodiment of the present disclosure, the multi carrier system 108 enables accessibility of new messages and missed calls on the multi carrier device 110.

In yet another embodiment of the present disclosure, the multi carrier system 108 is associated with one or more home location register corresponding to the plurality of carriers. In yet another embodiment of the present disclosure, the multi carrier system 108 is configured to copy the one or more attributes of the third set of attributes from the home location register 114. In an embodiment of the present disclosure, the replication engine 204e copies the one or more attributes of the third set of attributes from the cloud server. In an embodiment of the present disclosure, an application installed on the multi carrier device 110 triggers the copying of the one or more attributes of the third set of attributes.

Extending the above stated example, the comparator module 204d successfully matches the operating system (Android) and the carrier (Verizon Wireless) of the smart phone Samsung Galaxy Note 4 of the user X with the same operating system (Android) and the same carrier (Verizon Wireless) of the device Y installed in the car AUDI R8. The subscriber identity module card Z in the smart phone Samsung Galaxy Note 4 is associated with MSISDN number A. The replication engine 204e copies the number A onto the device Y. The user X uses the number A on the device Y for utilizing one or more features.

Going further, the execution engine 204f in the processor 204 provides a pre-determined set of services to the user 104 on the multi carrier device 110. The provision of the pre-determined set of services is based on the authentication of the user 104 and the matching of the personal computing device 106 with the multi carrier device 110 (as stated above in the patent application). The execution engine 204f enables the user 104 to access specialized applications installed in the multi carrier device 110 if result of the authentication of the user 104 and the matching of the personal computing device 106 with the multi carrier device 110 is positive. Moreover, the execution engine 204f enables the user to access limited and specific types of applications on the multi carrier device 110 if the result of the matching of the personal computing device 106 with the multi carrier device 110 is negative and the authentication of the user 104 is positive.

The specialized applications installed in the multi carrier device include but may not be limited to navigation applications, music applications, social networking applications, messaging applications, telephone applications and gaming applications. The user 104 accesses telephone and messaging applications on the multi carrier device 110 in case of no matching of the operating system and the carrier between the personal computing device 106 and the multi carrier device 110. In an embodiment of the present disclosure, the user 104 utilizes the telephone and the messaging applications through an in-built phone number of the multi carrier device 108.

In another embodiment of the present disclosure, the execution engine 204f provisions the user 104 to access one or more free or open source applications on the multi carrier device 110 in the case of no matching between the operating system of the personal computing device 106 and the multi carrier device 110. In yet another embodiment of the present disclosure, the multi carrier device 110 stores the one or more free or open source applications for allowing the user 104 to access some applications in case of non-compatible operating systems.

For example, a user H possessing a Android OS based device I wants to access applications on a device J embedded in a vehicle K. The user H cannot access android specific applications installed on the device J due to incompatibility between operating systems of the device I and the device J. The device J supports iOS and Windows operating systems. The execution engine 204f provides the user H with one or more open source applications (say Wikipedia, ChatSecure and Wordpress) which are Android specific and compatible with the iOS.

In an embodiment of the present disclosure, the execution engine 204f provides the one or more free or open source applications by executing an algorithm for best matching of applications compatible between the non-matched operating systems of the personal computing device 106 and the multi carrier device 110.

In an embodiment of the present disclosure, the execution engine 204f provides the specialized applications which support the matched operating system of the multi carrier device 110. In another embodiment of the present disclosure, the execution engine 204f provides the voice and data services corresponding to the matched carrier of the multi carrier device 110.

In yet another embodiment of the present disclosure, the multi carrier system 108 provides one or more options to the user 104 for restricting unauthorized access to the multi carrier device 110 by other one or more users. The one or more options include scheduling identities for a specified time of a day based on a regular use of the vehicle 102 on that specified time of the day or date. In yet another embodiment of the present disclosure, the user 104 specifies a first list of phone numbers which are allowed to access the multi carrier device 110. In yet another embodiment of the present disclosure, the user 104 specifies a second list of phone numbers which are not allowed to access the multi carrier device 110.

In yet another embodiment of the present disclosure, the multi carrier system 108 sets arbitrarily complex sets of permissions for allowing access to the multi carrier device 110. In yet another embodiment of the present disclosure, the multi carrier system 108 automatically assigns an identity to the user 104 based on the specified time of the day or specified date. In yet another embodiment of the present disclosure, the multi carrier system 108 automatically enables an identity for the user 104 based on the time of the day at which the user 104 usually drives the vehicle 102. For example, a user M drives a vehicle N equipped with a device O everyday between a time period of 8 A.M and 6 P.M. The multi carrier system 108 stores the time period (8 A.M and 6 P.M) and automatically assigns the user M with the identity in order to access the device O.

Continuing with the above stated example, the execution engine 204f provides the user X an access to one or more specialized applications corresponding to the matched operating system (Android) and the carrier (Verizon Wireless) on the device Y based on the successful authentication and the matching of the operating system (Android) and the carrier (Verizon Wireless). The user X access a navigation application (say Google Maps) on the device Y operating presently on the Android operating system. Similarly, the user X accesses more applications that are Android specific. The user X utilizes the voice services and data services according to settings of the Verizon Wireless carrier on the device Y. In addition, the user X accesses internet on the Android browser on the device Y by utilizing the data services of the Verizon Wireless carrier.

In an embodiment of the present disclosure, the multi carrier system 108 performs the enabling of the user 102 to access the multi carrier device 110 when the personal computing device 106 is a dual sim device based on a pre-determined criterion. In an embodiment of the present disclosure, the multi carrier system 108 allows the user 102 to choose a carrier from two carriers as a favorite for connecting with the multi carrier device 110. In another embodiment of the present disclosure, the carrier is chosen based on a current time of a day. In yet another embodiment of the present disclosure, the carrier is switched from one carrier to another based on a change in the current time of the day. In an embodiment of the present disclosure, the user 102 having more than one personal computing device 106 is allowed to choose a range of time where the user 102 will utilize a first device and another range of time where the user 102 utilizes a second device.

In an embodiment of the present disclosure, the choosing of the device is done automatically or manually. In an embodiment of the present disclosure, the multi carrier system 108 allows an option to the user 102 to switch from one device associated with a first carrier to another device associated with a second carrier based on a current signal strength of the first carrier, cost and the like.

Moreover, the database 204g in the processor stores the plurality of carriers supported by the multi carrier device 110, the plurality of operating systems supported by the multi carrier device 110, the one or more attributes of the first set of attributes associated with the user 104, the one or more attributes of the third set of attributes associated with the user 104, the operating system supported by the personal computing device 106, the carrier corresponding to the subscriber identity module 106a in the personal computing device 106, time of a day and date on which the user 104 accesses the multi carrier device 110, the first list of phone numbers and the second list of phone numbers.

In an embodiment of the present disclosure, the personal computing device 106 of the user 104 may be a dual SIM device.

In another embodiment of the present disclosure, the multi carrier device 110 is a touch screen device. Further, the touch screen may be capacitive type, resistive type and the like.

In yet another embodiment of the present disclosure, the multi carrier device 110 receives constant power for continuous operation from a battery associated with the vehicle 102.

In yet another embodiment of the present disclosure, more than one multi carrier device 110 may be installed in the vehicle 102 for supporting more than one user simultaneously.

In yet another embodiment of the present disclosure, the multi carrier device 110 may be controlled by the user 104 by voice control, joysticks gestures on a touch screen of the multi carrier device 110 or space, keyboard, mouse and touchpad.

Going further, the communication device 202 includes any suitable type of portable electronic device. Examples of the communication device 202 include but may not be limited to a personal e-mail device (e.g., a Blackberry™ made available by Research in Motion of Waterloo, Ontario), a personal data assistant (“PDA”), a cellular telephone, a Smartphone, a handheld gaming device, a digital camera, the laptop computer, and a tablet computer. In another embodiment of the present disclosure, the communication device 202 can be a desktop computer.

From the perspective of this disclosure, the control circuitry module 206 includes any processing circuitry or processor operative to control the operations and performance of the communication device 202. For example, the control circuitry module 206 may be used to run operating system applications, firmware applications, media playback applications, media editing applications, or any other application. In an embodiment, the control circuitry module 206 drives a display and process inputs received from a user interface.

From the perspective of this disclosure, the storage module 208 includes one or more storage mediums including a hard-drive, solid state drive, flash memory, permanent memory such as ROM, any other suitable type of storage component, or any combination thereof. The storage module 208 may store, for example, media data (e.g., music and video files), application data (e.g., for implementing functions on the communication device 202).

From the perspective of this disclosure, the input/output circuitry module 210 may be operative to convert (and encode/decode, if necessary) analog signals and other signals into digital data. In an embodiment, the input/output circuitry module 210 may also convert the digital data into any other type of signal and vice-versa. For example, the input/output circuitry module 210 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 206, the storage module 208 or any other component of the communication device 202.

It may be noted that the input/output circuitry module 210 is illustrated in FIG. 2 as a single component of the communication device 202; however those skilled in the art would appreciate that several instances of the input/output circuitry module 210 may be included in the communication device 202.

The communication device 202 may include any suitable interface or component for allowing the user 104 to provide inputs to the input/output circuitry module 210. The communication device 202 may include any suitable input mechanism. Examples of the input mechanism include but may not be limited to a button, keypad, dial, a click wheel, and a touch screen. In an embodiment, the communication device 202 may include a capacitive sensing mechanism, or a multi-touch capacitive sensing mechanism.

In an embodiment, the communication device 202 may include specialized output circuitry associated with output devices such as, for example, one or more audio outputs. The audio output may include one or more speakers built into the communication device 202, or an audio component that may be remotely coupled to the communication device 202.

The one or more speakers can be mono speakers, stereo speakers, or a combination of both. The audio component can be a headset, headphones or ear buds that may be coupled to the communication device 202 with a wire or wirelessly.

In an embodiment, the input/output circuitry module 210 may include display circuitry for providing a display visible to the user 104. For example, the display circuitry may include a screen (e.g., an LCD screen) that is incorporated in the communication device 202.

The display circuitry may include a movable display or a projecting system for providing a display of content on a surface remote from the communication device 202 (e.g., a video projector). In an embodiment, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 206. Alternatively, the display circuitry may be operative to provide instructions to a remote display.

In addition, the communication device 202 includes the communication circuitry module 212. The communication circuitry module 212 may include any suitable communication circuitry operative to connect to a communication network and to transmit communications (e.g., voice or data) from the communication device 202 to other devices within the communications network. The communication circuitry module 212 may be operative to interface with the communication network using any suitable communication protocol. Examples of the communication protocol include but may not be limited to Wi-Fi, Bluetooth RTM, radio frequency systems, infrared, LTE, GSM, GSM plus EDGE, CDMA, and quadband.

In an embodiment, the communication circuitry module 212 may be operative to create a communications network using any suitable communications protocol. For example, the communication circuitry module 212 may create a short-range communication network using a short-range communications protocol to connect to other devices. For example, the communication circuitry module 212 may be operative to create a local communication network using the Bluetooth, RTM protocol to couple the communication device 202 with a Bluetooth, RTM headset.

It may be noted that the computing device is shown to have only one communication operation; however, those skilled in the art would appreciate that the communication device 202 may include one more instances of the communication circuitry module 212 for simultaneously performing several communication operations using different communication networks. For example, the communication device 202 may include a first instance of the communication circuitry module 212 for communicating over a cellular network, and a second instance of the communication circuitry module 212 for communicating over Wi-Fi or using Bluetooth RTM.

In an embodiment, the same instance of the communication circuitry module 212 may be operative to provide for communications over several communication networks. In an embodiment, the communication device 202 may be coupled a host device for data transfers, synching the communication device 202, software or firmware updates, providing performance information to a remote source (e.g., providing riding characteristics to a remote server) or performing any other suitable operation that may require the communication device 202 to be coupled to a host device. Several computing devices may be coupled to a single host device using the host device as a server. Alternatively or additionally, the communication device 202 may be coupled to the several host devices (e.g., for each of the plurality of the host devices to serve as a backup for data stored in the communication device 202).

It may be noted that in FIG. 2, the database 204g stores the one or more information associated with the user 104, however those skilled in the art would appreciate that the database 204g stores the one or more information of more number of users. It may also be noted in FIG. 2, the authentication engine 204b authenticates the user 104 for accessing the multi carrier device 110, however those skilled in the art would appreciate that the authentication engine 204b authenticates more number of users.

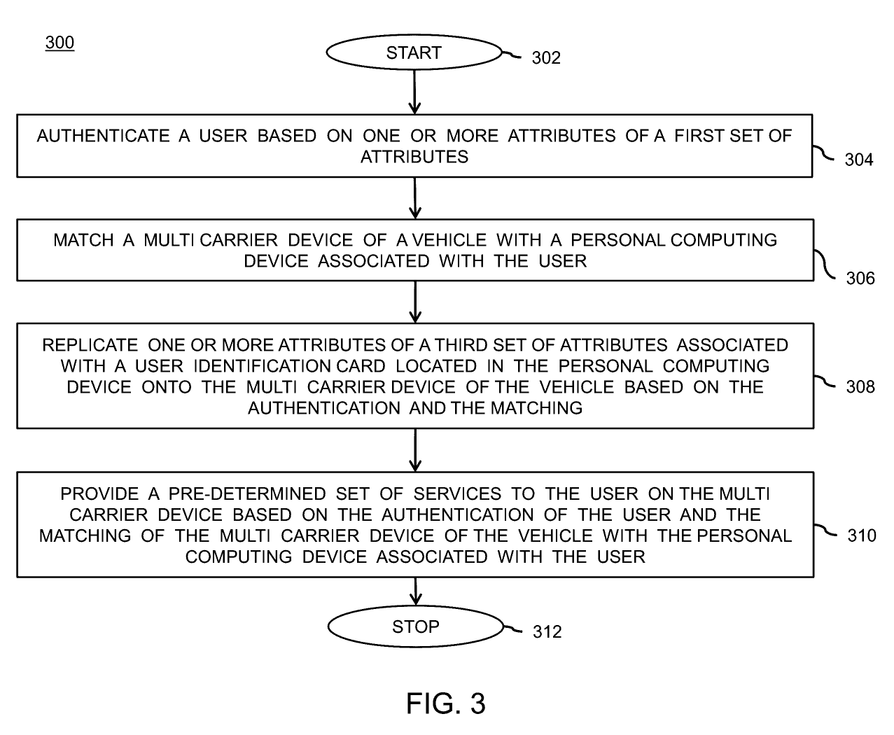

FIG. 3 illustrates a flowchart 300 for enabling the one or more users to access the multi carrier based device of the vehicle, in accordance with various embodiments of the present disclosure. The flowchart 300 initiates at step 302. At step 304, the authentication engine 204b authenticates the user 104 based on the received one or more attributes of the first set of attributes. At step 306, the comparator module 204d matches the multi carrier device 110 of the vehicle 102 and the personal computing device 106 associated with the user 104. The matching is based on the one or more attributes of the second set of attributes associated with the personal computing device 106 and the multi carrier device 110. At step 308, the replication engine 204e replicates the one or more attributes of the third set of attributes associated with the user identification information stored in the personal computing device 106 onto the multi carrier device 110 embedded in the vehicle 102 based on the authentication and the matching. At step 310, the execution engine 204f provides the pre-determined set of services to the user 104 on the multi carrier device 110 based on the authentication of the user 104 and the matching of the multi carrier device 110 with the personal computing device 106. The flowchart 300 terminates at step 312.

It may be noted that the flowchart 300 is explained to have above stated process steps; however, those skilled in the art would appreciate that the flowchart 300 may have more/less number of process steps which may enable all the above stated embodiments of the present disclosure.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A computer-implemented method for enabling one or more users to access a multi carrier device of a vehicle, the computer-implemented method comprising:
authenticating, with a processor, the user based on one or more attributes of a first set of attributes, wherein the authenticating being performed for verification of a user of the one or more users for accessing the multi carrier device of the vehicle;
matching, with the processor, the multi carrier device of the vehicle with a personal computing device associated with the user of the one or more users, wherein the matching being based on one or more attributes of a second set of attributes associated with the personal computing device of the user and the multi carrier device of the vehicle;
replicating, with the processor, one or more attributes of a third set of attributes associated with a user identification information stored in the personal computing device onto the multi carrier device of the vehicle based on the authentication and the matching, wherein the replicating being performed by copying of the one or more attributes of the third set of attributes stored in a carrier database associated with the user identification information stored in the personal computing device onto the multi carrier device of the vehicle; and
providing, with the processor, a pre-determined set of services to the user on the multi carrier device based on the authentication of the user and the matching of the multi carrier device of the vehicle with the personal computing device associated with the user.

2. The computer-implemented method as recited in claim 1, further comprising receiving, with the processor, the one or more attributes of the first set of attributes associated with the user present in the vehicle.

3. The computer-implemented method as recited in claim 1, further comprising detecting, with the processor, the personal computing device associated with the authenticated user present in the vehicle.

4. The computer-implemented method as recited in claim 1, wherein the one or more attributes of the first set of attributes comprises at least one of a username, a password, a fingerprint input of the user, a voiceprint input of the user, an image of the user, retina analysis of the user and a heartbeat input of the user, an RFID token, and a palm vein pattern.

5. The computer-implemented method as recited in claim 1, wherein the one or more attributes of the second set of attributes comprises at least one of an operating system and a carrier associated with the personal computing device and the multi carrier device, wherein the carrier provides mobile communication services to the user.

6. The computer-implemented method as recited in claim 1, wherein the multi carrier device supports a plurality of carriers and a plurality of operating systems.

7. The computer-implemented method as recited in claim 1, wherein the one or more attributes of the third set of attributes associated with the user identification information stored in the personal computing device comprises one or more information associated with the user, wherein the one or more information comprises at least one of a unique directory number provided to the user, an ID associated with the user, billing information of the user, current location of the user, status of the user, one or more services rendered by the user and one or more web links associated with the user.

8. The computer-implemented method as recited in claim 1, wherein the multi carrier device is controlled by at least one of a voice control, joysticks gestures on a touch screen or space, keyboard, mouse, a touchpad, an eye-tracking mouse and a chord key board.

9. A system for enabling one or more users to access a multi carrier device of a vehicle, the system comprising:
an authentication engine in a processor, the authentication engine being configured to authenticate a user of the one or more users based on one or more attributes from a first set of attributes, wherein the authentication being performed for verification of the user for accessing the multi carrier device of the vehicle;
a comparator module in the processor, the comparator module being configured to match the multi carrier device of the vehicle with a personal computing device associated with the user of the one or more users, wherein the matching being based on one or more attributes of a second set of attributes associated with the personal computing device of the user and the multi carrier device of the vehicle;
a replication engine in the processor, the replication engine being configured for replicating one or more attributes of a third set of attributes associated with a user identification information stored in the personal computing device onto the multi carrier device of the vehicle based on the authentication and the matching, wherein the replicating being performed by copying of the one or more attributes of the third set of attributes stored in a carrier database associated with the user identification information stored in the personal computing device onto the multi carrier device of the vehicle; and
an execution engine in the processor, the execution engine in the processor being configured to provide a pre-determined set of services to the user on the multi carrier device based on the authentication of the user and the matching of the multi carrier device of the vehicle with the personal computing device associated with the user.

10. The system as recited in claim 9, further comprising a receiving module in the processor, the receiving module being configured to receive the one or more attributes of the first set of attributes associated with the user present in the vehicle.

11. The system as recited in claim 9, further comprising a detection module in the processor, the detection module being configured to detect the personal computing device associated with the authenticated user present in the vehicle.

12. The system as recited in claim 9, wherein the one or more attributes of the first set of attributes comprises at least one of a username, a password, a fingerprint input of the user, a voiceprint input of the user, an image of the user, retina analysis of the user and a heartbeat input of the user.

13. The system as recited in claim 9, wherein the one or more attributes from the second set of attributes comprises at least one of an operating system and a carrier associated with the personal computing device and the multi carrier device, wherein the carrier provides mobile communication services to the user.

14. The system as recited in claim 9, wherein the multi carrier device supports a plurality of carriers and a plurality of operating systems.

15. The system as recited in claim 9, wherein the one or more attributes from the third set of attributes associated with the user identification information stored in the personal computing device comprises one or more information associated with the user, wherein the one or more information comprises at least one of a unique directory number provided to the user, an ID associated with the user, billing information of the user, current location of the user, status of the user and one or more services rendered by the user.

16. The system as recited in claim 9, wherein the multi carrier device is controlled by at least one of a voice control, joysticks gestures on a touch screen or space, keyboard, mouse and touchpad.

17. A computer program product comprising a non-transitory computer readable medium storing a computer readable program, wherein said computer readable program when executed on a computer causes said computer to perform steps comprising:
authenticating a user of one or more users based on one or more attributes of a first set of attributes, wherein the authenticating being performed for verification of the user for accessing a multi carrier device of a vehicle;
matching the multi carrier device of the vehicle with a personal computing device associated with the user of the one or more users, wherein the matching being based on one or more attributes of a second set of attributes associated with the personal computing device of the user and the multi carrier device of the vehicle;
replicating one or more attributes of a third set of attributes associated with a user identification information located in the personal computing device onto the multi carrier device of the vehicle based on the authentication and the matching, wherein the replicating being performed by copying of the one or more attributes of the third set of attributes stored in a carrier database associated with the user identification information stored in the personal computing device onto the multi carrier device of the vehicle; and
providing a pre-determined set of services to the user on the multi carrier device based on the authentication of the user and the matching of the multi carrier device of the vehicle with the personal computing device associated with the user.

18. The computer program product as recited in claim 17, wherein the computer readable program when executed on the computer causes the computer to perform a further step of receiving the one or more attributes of the first set of attributes associated with the user present in the vehicle.

19. The computer program product as recited in claim 17, wherein the computer readable program when executed on the computer causes the computer to perform a further step of detecting the personal computing device associated with the authenticated user present in the vehicle.

20. The computer program product as recited in claim 17, wherein the one or more attributes of the first set of attributes comprises at least one of a username, a password, a fingerprint input of the user, a voiceprint input of the user, an image of the user, retina analysis of the user and a heartbeat input of the user.
